(19) United States
(12) Patent Application Publication
(10) Pub. No.: US 2003/0012315 A1
(43) Pub. Date: Jan. 16, 2003

(54) System and method for multistage error correction coding wirelessly transmitted information in a multiple antennae communication system

(76) Inventor: John Fan, Palo Alto, CA (US)

Correspondence Address: Patent Department, Iospan Wireless, P.O. Box 641867, San Jose, CA, 95164-1867, US

(21) Appl. No.: 09/900,110

(22) Filed: Jul. 6, 2001

(51) Int. Cl. H04B 1/10

(52) U.S. Cl. 375/349

(57) ABSTRACT

The invention includes an apparatus and a method of error correction coding data wirelessly transmitted through multiple transmission channels. The method includes receiving a plurality of data streams for transmission through spatially separate antennae. At least one bit from each of a plurality of data streams is selected forming a first bit grouping. At least one other bit from each of the plurality of the data streams is selected forming a second bit grouping. The first bit grouping is coded. The second bit grouping is coded. Finally, the coded first bit grouping and the coded second bit grouping are transmitted. The invention also includes a method of error correction decoding data wirelessly received through multiple transmission channels. The method includes receiving a plurality of data streams received through spatially separate antennae. At least one bit from each of the plurality of data streams is selected forming a first bit grouping. At least one other bit from each of the plurality of the data streams is selected forming a second bit grouping. The first bit grouping is decoded. The second bit grouping is decoded. Decoded bit streams are constructed based upon the decoded first bit grouping and the decoded second bit grouping.

### FIELD OF THE INVENTION

The invention relates generally to error correction coding. More particularly, the invention relates to a system and method for multilevel coding and multistage decoding in a multiple antennae wireless communication system.

### BACKGROUND OF THE INVENTION

Wireless communication systems commonly include information-carrying modulated carrier signals that are wirelessly transmitted from a transmission source (for example, a base transceiver station) to one or more receivers (for example, subscriber units) within an area or region.

A form of wireless communication includes multiple transmit antennae and multiple receiver antennae. Multiple antennae communication systems can support communication diversity and spatial multiplexing.

Spatial Multiplexing

Spatial multiplexing is a transmission technology that exploits multiple antennae at both the base transceiver station and at the subscriber units to increase the bit rate in a wireless radio link with no additional power or bandwidth consumption. Under certain conditions, spatial multiplexing offers a linear increase in spectrum efficiency with the number of antennae. For example, if three antennae are used at the transmitter (base transceiver station) and the receiver (subscriber unit), the stream of possibly coded information symbols is split into three independent substreams. These substreams occupy the same channel of a multiple access protocol. Possible same channel multiple access protocols include a same time slot in a time-division multiple access protocol, a same frequency slot in frequency-division multiple access protocol, a same code sequence in code-division multiple access protocol or a same spatial target location in space-division multiple access protocol. The substreams are applied separately to the transmit antennae and transmitted through a radio channel. Due to the presence of various scattering objects in the environment, each signal experiences multipath propagation.

The composite signals resulting from the transmission are finally captured by an array of receiving antennae with random phase and amplitudes. At the receiver array, a spatial signature of each of the received signals is estimated. Based on the spatial signatures, a signal processing technique is applied to separate the signals, recovering the original substreams.

FIG. 1 shows three transmitter antenna arrays 110, 120, 130 that transmit data symbols to a receiver antenna array 140. Each transmitter antenna array and each receiver antenna array include spatially separate antennae. A receiver connected to the receiver antenna array 140 separates the received signals.

FIG. 2 shows modulated carrier signals traveling from a transmitter 210 to a receiver 220 following many different (multiple) transmission paths.

Multipath can include a composition of a primary signal plus duplicate or echoed images caused by reflections of signals off objects between the transmitter and receiver. The receiver may receive the primary signal sent by the transmitter, but also receives secondary signals that are reflected off objects located in the signal path. The reflected signals arrive at the receiver later than the primary signal. Due to this misalignment, the multipath signals can cause intersymbol interference or distortion of the received signal.

The actual received signal can include a combination of a primary and several reflected signals. Because the distance traveled by the original signal is shorter than the reflected signals, the signals are received at different times. The time difference between the first received and the last received signal is called the delay spread and can be as great as several micro-seconds.

The multiple paths traveled by the modulated carrier signal typically results in fading of the modulated carrier signal. Fading causes the modulated carrier signal to attenuate in amplitude when multiple paths subtractively combine.

Communication Diversity

Antenna diversity is a technique used in multiple antenna-based communication system to reduce the effects of multi-path fading. Antenna diversity can be obtained by providing a transmitter and/or a receiver with two or more antennae. These multiple antennae imply multiple channels that suffer from fading in a statistically independent manner. Therefore, when one channel is fading due to the destructive effects of multi-path interference, another of the channels is unlikely to be suffering from fading simultaneously. By virtue of the redundancy provided by these independent channels, a receiver can often reduce the detrimental effects of fading.

Several techniques can be used for receiving and decoding multiple input, multiple output (MIMO) transmission channels. The channel for a typical MIMO system can be represented by:

Y=HX+N

$$[ \begin{matrix}{Y}_{l} \\ ⋮ \\ {Y}_{M r}\end{matrix} ] = [ \begin{matrix}{H}_{i , l} & & {H}_{l , M t} \\ & & \\ {H}_{M r , l} & & {H}_{M t , M r}\end{matrix} ] [ \begin{matrix}{X}_{l} \\ ⋮ \\ {X}_{Mt}\end{matrix} ] + [ \begin{matrix}{N}_{l} \\ ⋮ \\ {N}_{M r}\end{matrix} ]$$

Where Y is the received signals, X is the transmit signals, H is the channel matrix and N is additive noise. Mₜ is the number of transmit antennae and Mᵣ is the number of receive antennae.

Possible techniques for receiving and decoding the transmitted signals include linear equalization, maximum likelihood, and BLAST.

Linear equalization includes calculating a pseudo-inverse matrix for the above-defined H matrix. A linear filter W is determined such that WY approximates the original transmitted signal X. The filter W can be determined using a minimum mean-square error (MMSE). The received signals are separately decoded. Increasing the number of antennae degrades the performance of linear equalization.

Maximum likelihood includes searching all possible combinations of the received data to determine the sequence that was most likely to have been transmitted based on the received vector information Y, and a model for additive noise (generally Gaussian). Generally, maximum likelihood includes searching over (2^{S})^{Mt} combinations of transmit signals, where S is the number of bits per transmitted QAM symbol, and Mt is the number of transmit antennae. This method becomes computationally infeasible for a large number of antennae.

BLAST (Bell-Labs Layered Space-Time) provides a computationally efficient method of decoding based on locating the strongest signal and decoding it first. The located strongest signal is then subtracted out, and the next strongest signal is located. This process is continued until the different signals are successively located in a layered approach. This method involves complex signal processing for determining the strongest signal through the determination of a special decomposition of the channel matrix H.

It is desirable to have a system and method that provides a wireless communication system between multiple antenna transmitters and receivers in which the design of the receivers within the system can be simplified. Additionally, it is desirable that the system be able to adapt to poor quality transmission links.

### SUMMARY OF THE INVENTION

As shown in the drawings for purposes of illustration, the invention is embodied in a system and a method for wirelessly transmitting data through multiple transmission antennae that allows for receiver simplification and adaptation to a poor transmission link. The receiver simplification and link adaptation is accomplished through layered coding of data symbols transmitted through the multiple input, multiple output (MIMO) channels.

A first embodiment of the invention includes a method of error correction coding data wirelessly transmitted through multiple transmission channels. The method includes receiving a plurality of data streams for transmission through spatially separate antennae. At least one bit from each of a plurality of data streams is selected forming a first bit grouping. At least one other bit from each of the plurality of the data streams is selected forming a second bit grouping. The first bit grouping is coded. The second bit grouping is coded. Finally, the coded first bit grouping and the coded second bit grouping are transmitted.

A second embodiment of the invention is similar to the first embodiment. For the second embodiment, selecting at least one bit from each of a plurality of the data streams forming a first bit grouping includes selecting a plurality of bits from each data stream, and selecting at least one bit from each of a plurality of the data streams forming a second bit grouping includes selecting a plurality of other bits from each data stream.

A third embodiment is similar to the second embodiment. The third embodiment includes coding the first bit grouping according to at least one of Reed-Solomon coding, convolutional coding, turbo coding and low-density parity check coding, and coding the second bit grouping according to at least one of Reed-Solomon coding, convolutional coding, turbo coding and low-density parity check coding.

A fourth embodiment is similar to the first embodiment. The fourth embodiment includes the data streams including N-QAM symbols. The first bit grouping and the second bit grouping can be based upon the significance of the bits within the N-QAM symbols. The first bit grouping selections and the second bit grouping selections can include selecting a plurality of bits from the N-QAM symbols from the plurality of the bit streams. Redundancy in coding the first bit grouping and coding the second bit grouping can be dependent upon the significance of the bits within the first bit grouping and the second bit grouping.

A fifth embodiment is similar to the fourth embodiment. The fifth embodiment includes the N-QAM symbols of the data streams being modulated on simultaneously transmitted multi-carrier signals after the bits of the N-QAM symbols have been coded. The multi-carrier signals can be orthogonal frequency division multiplexed (OFDM) signals.

A sixth embodiment includes a method of error correction decoding data wirelessly received through multiple transmission channels. The method includes receiving a plurality of data streams received through spatially separate antennae. At least one bit from each of the plurality of data streams is selected forming a first bit grouping. At least one other bit from each of the plurality of the data streams is selected forming a second bit grouping. The first bit grouping is decoded. The second bit grouping is decoded. Decoded bit streams are constructed based upon the decoded first bit grouping and the decoded second bit grouping.

A seventh embodiment includes a method of multistage error decoding. The method includes receiving a plurality of data streams through spatially separate antennae. First level bits are generated based upon decoding of first common bit groupings within the received data streams. Second level bits are generated based upon subtracting the first level bits from the received plurality of data streams, and decoding second common bit groupings within the received data streams. Finally, the first level bits and the second level bits are combined forming multistage decoded bit streams.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes spatially separate transmitter antennae and spatially separate receiver antennae.

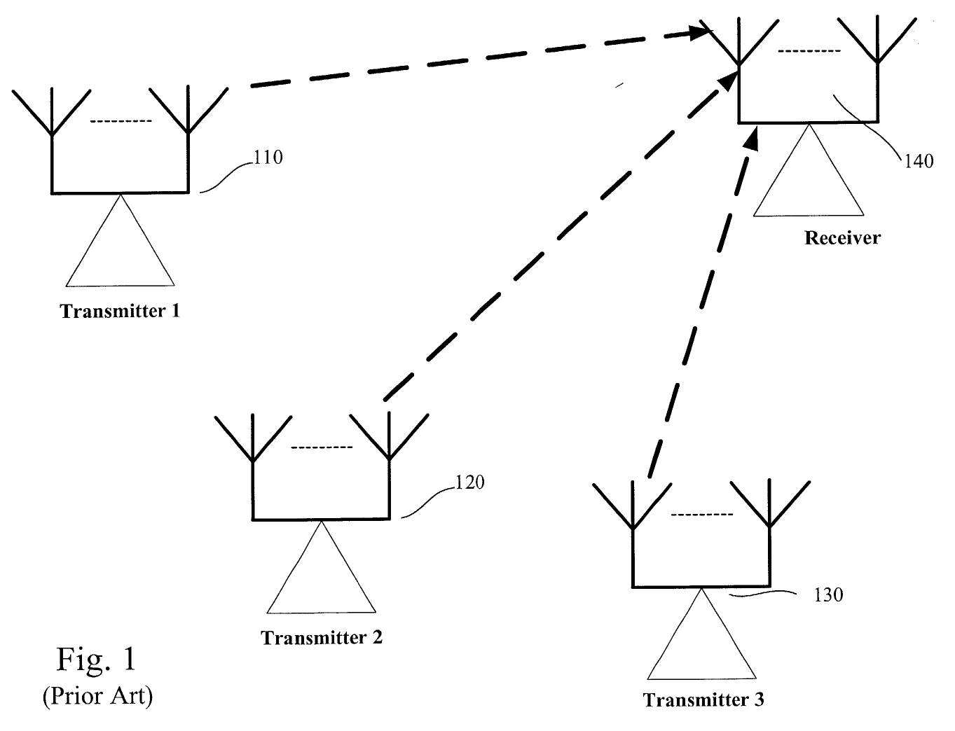

FIG. 2 shows a prior art wireless system that includes multiple paths from a system transmitter to a system receiver.

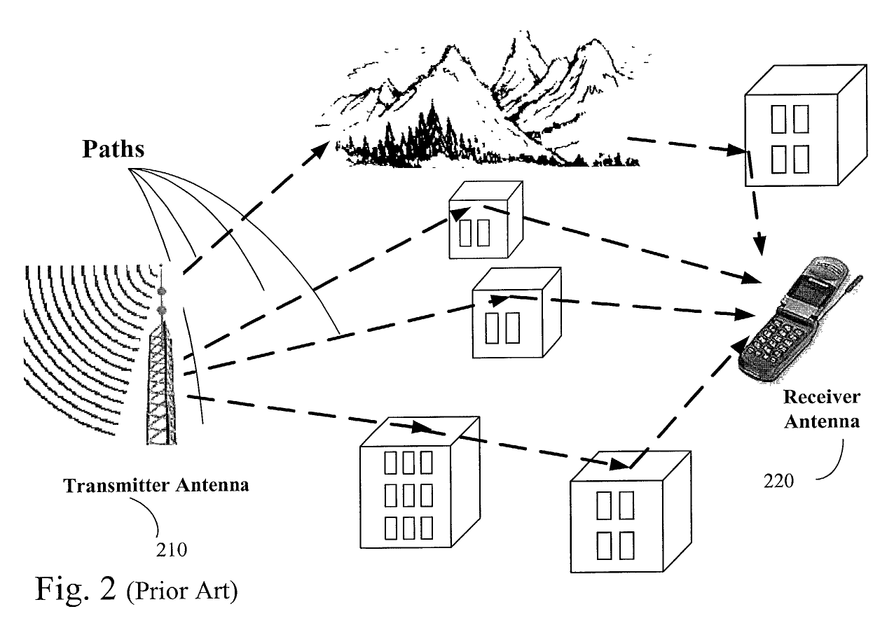

FIG. 3 shows a flow chart depicting steps included within a method of wireless transmission according to the invention.

FIG. 4 shows a flow chart depicting steps included within a method of wireless reception according to the invention.

FIG. 5 shows a high level transmitter diagram of an embodiment of the invention.

FIG. 6 shows a high-level receiver diagram of an embodiment of the invention.

FIG. 7 shows the frequency spectrum of a multi-carrier signal.

FIG. 8 show a configuration of a MIMO receiver.

FIG. 9 shows an embodiment of a MIMO receiver according to the invention.

FIG. 10 shows a transmitter that corresponds with the receiver of FIG. 9.

FIG. 11 shows a QAM constellation that depicts link adaptation advantages of the invention.

### DETAILED DESCRIPTION

As shown in the drawings for purposes of illustration, the invention is embodied in an system and a method for wirelessly transmitting data through MIMO channels formed by multiple transmission and reception antennae that allows for receiver simplification and adaptation to a poor transmission link. The receiver simplification and link adaptation is accomplished through layered coding of data symbols transmitted through the MIMO channels.

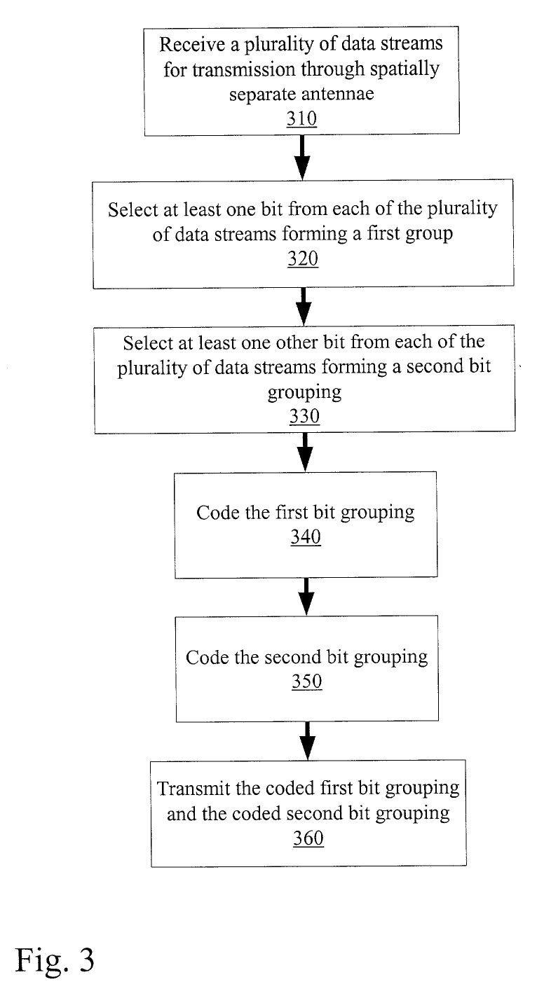

FIG. 3 shows a flow chart depicting steps included within a method of wireless transmission according to the invention.

A first step 310 includes receiving a plurality of data streams for transmission through spatially separate antennae. As previously described, the transmission can include spatial multiplexing or transmission diversity. Each data stream can correspond to a particular transmit antenna. Generally, the data steams have been encoded. Additionally, the data streams can be interleaved as is well know in the art of communication systems.

A second step 320 includes selecting at least one bit from each of the plurality of the data streams forming a first bit grouping. This selection can include any desired number of bits from each data stream. Generally, the data streams include data symbols and a number of bits are selected from corresponding symbols in each data stream.

A third step 330 includes selecting at least one other bit from each of the plurality of the data streams forming a second bit grouping. As with the first bit grouping, this selection can include any desired number of bits from each data stream. Generally, the data streams include data symbols and a number of bits are selected for the second bit grouping come from corresponding symbols in each data stream.

A fourth step 340 includes coding the first bit grouping. That is, the first bit grouping can form a first code word.

A fifth step 350 includes coding the second bit grouping. That is, the second bit grouping can form a second code word. The groupings in step 340 and step 350 can be Reed-Solomon coding, convolutional coding, turbo coding or low density parity check coding. This is not an exhaustive list. As stated earlier, these coding types are well known in the art of communication systems.

A sixth step 360 includes transmitting the coded first bit grouping and the coded second bit grouping.

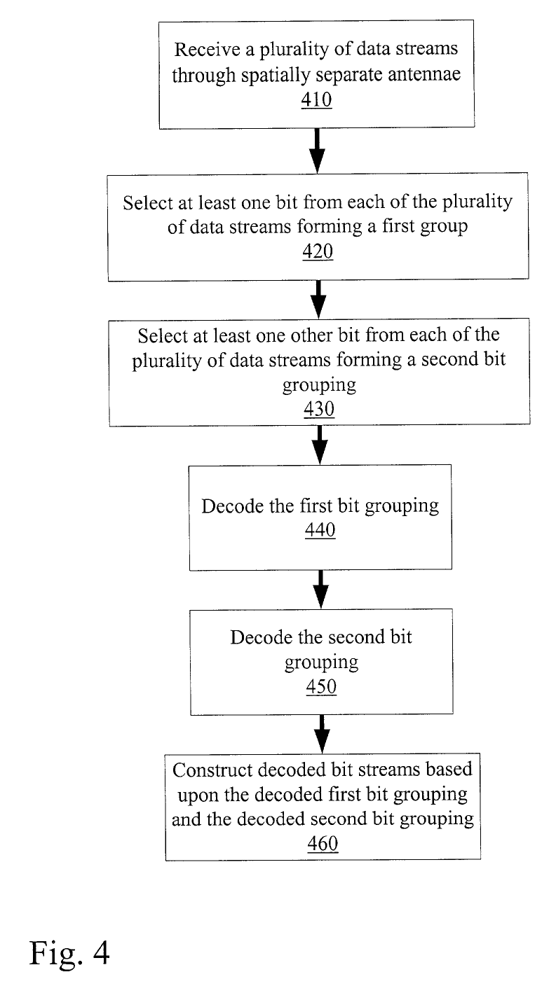

FIG. 4 shows a flow chart depicting steps included within a method of wireless reception according to the invention.

A first step 410 includes receiving a plurality of data streams received through spatially separate antennae.

A second step 420 includes selecting at least one bit from each of the plurality of the data streams forming a first bit grouping.

A third step 430 includes selecting at least one other bit from each of the plurality of the data streams forming a second bit grouping.

A fourth step 440 includes decoding the first bit grouping.

A fifth step 450 includes decoding the second bit grouping.

A sixth step includes constructing decoded bit streams based upon the coded first bit grouping and the coded second bit grouping.

High Level Transmitter Diagram

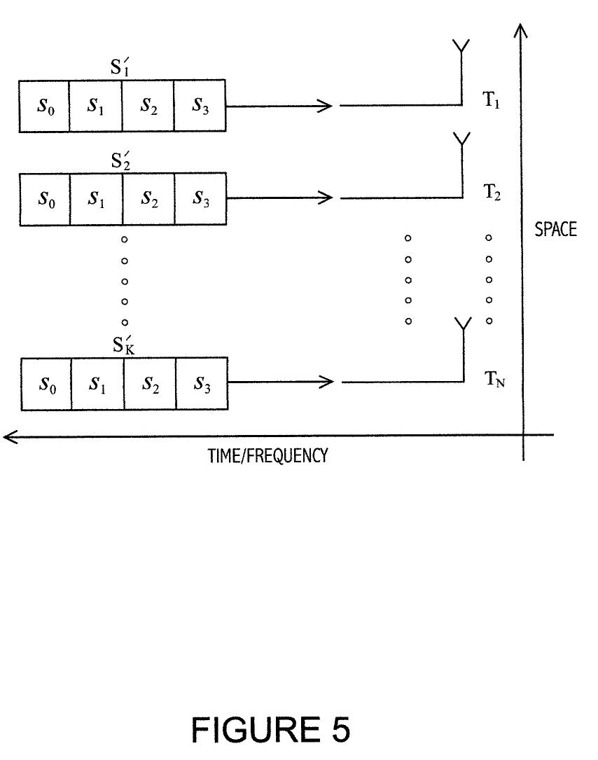

FIG. 5 shows a high-level transmitter diagram of an embodiment of the invention. FIG. 5 includes a set of data stream symbols S1, S2, . . . SK. The symbols S1, S2, . . . SK of FIG. 5, each include four data bits s0, s1, s2, s3. The bits of the symbols S1, S2, . . . SK correspond to encoded bits.

The axes of FIG. 5 show that transmitter antennae T1, T2, . . . TN are spatially separate. Each data stream of symbols S1, S2, . . . SK modulates a signal transmitted from a corresponding transmitter antennae T1, T2, . . . TN.

The axes of FIG. 5 also show that the data streams of symbols are spread across either time or frequency. The spreading of symbols across frequency will be described later in greater detail.

An embodiment of the invention includes the symbols S1, S2, . . . SK being N-QAM symbols. For this embodiment, the four data bit symbols represent 16-QAM symbols. It is to be understood, that the invention can include any order of N-QAM symbols. Additionally, the invention can be extended to include any order of N-PAM or N-PSK symbols.

An embodiment of the invention includes coding like data bits s0, s1, s2, s3 of the of different symbols S1, S2, . . . SK. For example, most significant data bits s0, s1 of the symbols S1, S2, . . . SK can be coded, and least significant data bits s2, s3 of the symbols S1, S2, . . . SK can be separately coded. This example includes two data bits per symbol for coding. However, the number of data bits from each symbol selected for coding is variable.

High Level Receiver Diagram

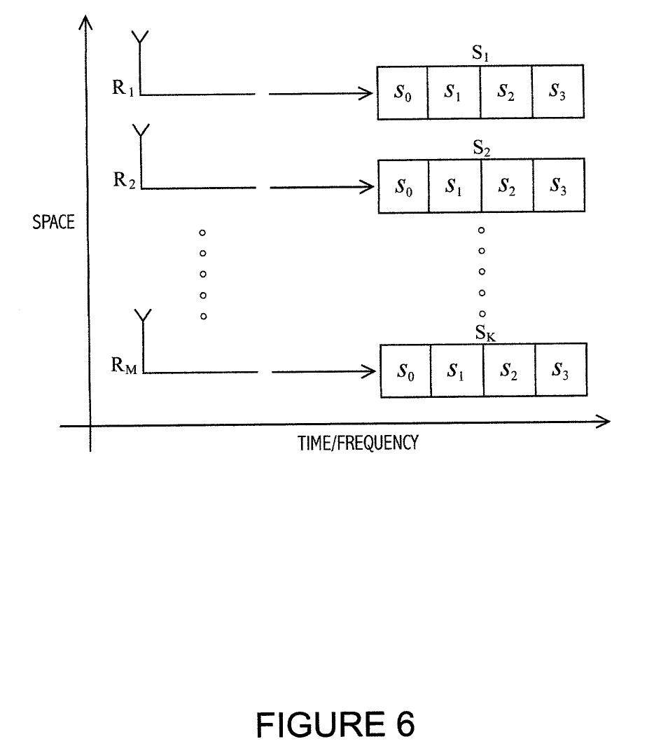

FIG. 6 shows a high-level receiver diagram of an embodiment of the invention. FIG. 6 includes a set of data stream symbols S1, S2, . . . SK. The symbols S1, S2, . . . SK of FIG. 6, each include four data bits s0, s1, s2, s3.

The axes of FIG. 6 show that receiver antennae R1, R2, . . . RM are spatially separate. Each data stream of symbols S1, S2, . . . SK is demodulated from a signal received by a corresponding receiver antennae R1, R2, . . . RM.

The axes of FIG. 6 also show that the data streams of symbols are spread across either time or frequency. The spreading of symbols across frequency will be described later in greater detail.

An embodiment of the invention includes the symbols S1, S2, . . . SK being N-QAM symbols. For this embodiment, the four data bit symbols represent 16-QAM symbols. It is to be understood, that the invention can include any order of N-QAM symbols. Additionally, the invention can be extended to include any order of N-PAM or N-PSK symbols.

An embodiment of the invention includes decoding like data bits s0, s1, s2, s3 of the different symbols S1, S2, . . . SK. For example, most significant data bits s0, s1 of the symbols S1, S2, . . . SK can be decoded, and least significant data bits s2, s3 of the symbols S1, S2, . . . SK can be decoded. This example includes two data bits per symbol for decoding. However, the number of data bits from each symbol selected for decoding is variable.

Orthogonal Frequency Division Multiplexing (OFDM) Modulation The frequency spectrum of the transmitted signals can include multiple modulated carriers. A example of a multiple carrier modulated system if orthogonal frequency division multiplexing (OFDM).

Frequency division multiplexing systems include dividing the available frequency bandwidth into multiple data carriers. OFDM systems include multiple carriers (or tones) that divide transmitted data across the available frequency spectrum. In OFDM systems, each tone is considered to be orthogonal (independent or unrelated) to the adjacent tones. OFDM systems use bursts of data, each burst of a duration of time that is much greater than the delay spread to minimize the effect of ISI caused by delay spread. Data is transmitted in bursts, and each burst consists of a cyclic prefix followed by data symbols, and/or data symbols followed by a cyclic suffix.

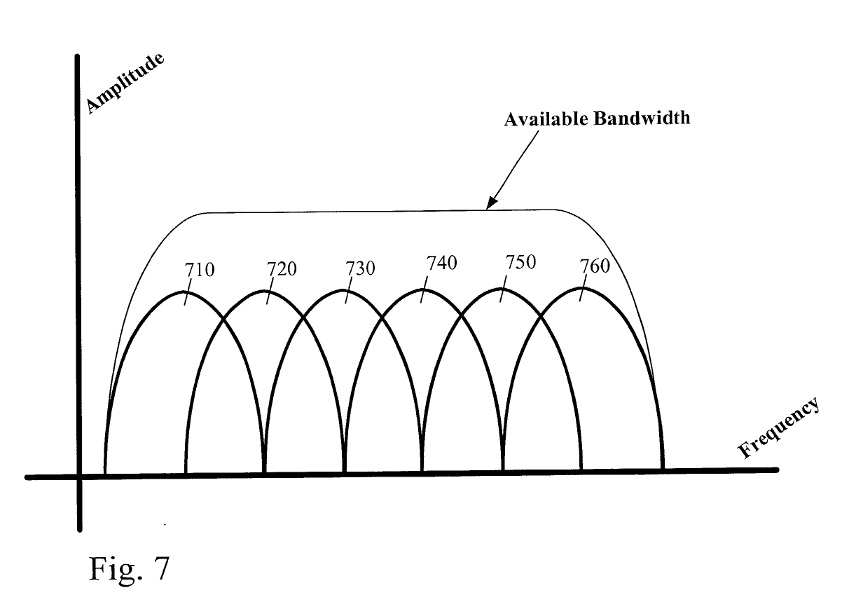

FIG. 7 shows a frequency spectrum of OFDM sub-carrier signals 710, 720, 730, 740, 750, 760. Each sub-carrier 710, 720, 730, 740, 750, 760 is modulated by separate symbols or combinations of symbols.

An examplary OFDM signal occupying 6 MHz is made up of 1024 individual carriers (or tones), each carrying a single QAM symbol per burst. A cyclic prefix or cyclic suffix is used to absorb transients from previous bursts caused by multipath signals. Additionally, the cyclic prefix or cyclic suffix causes the transmit OFDM waveform to look periodic. In general, by the time the cyclic prefix is over, the resulting waveform created by the combining multipath signals is not a function of any samples from the previous burst. Therefore, no ISI occurs. The cyclic prefix must be greater than the delay spread of the multipath signals.

The invention can include coding and decoding of bits within symbols that are spread across multiple carriers of a multi-carrier signal. Therefore, coding of the bits is spread over frequency as well as time.

Standard Receiver

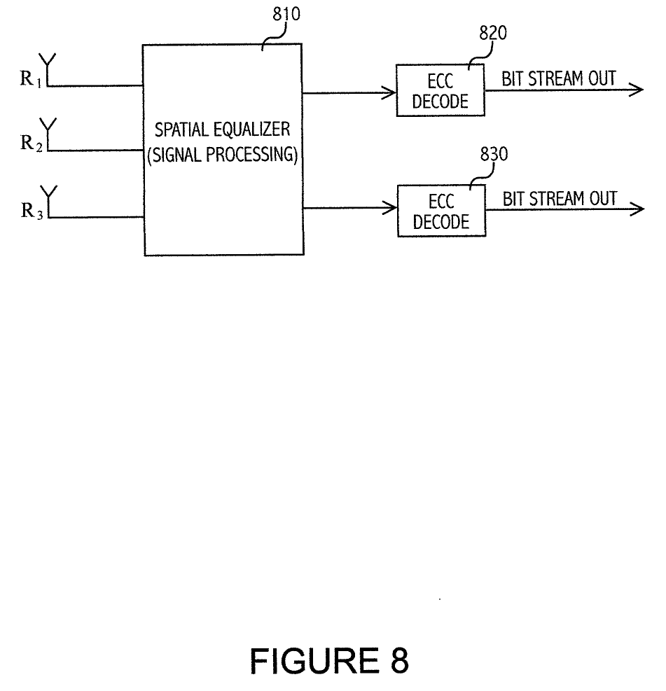

FIG. 8 show a configuration of a MIMO receiver. This MIMO receiver includes three spatially separate receiver antennae R1, R2, R3. Signals received by the receiver antennae R1, R2, R3 are separated through signal processing within a spatial equalizer 810 that requires transmission knowledge and characterization. Decoded bit streams are generated from the separated signals by error correction code (ECC) decoders 820, 830.

A common approach is to use linear spatial processing to undo the effects of the channel, and obtain signal estimates of the multiple transmitted streams. These signals can be processed separately. This method is suboptimal because the equalization is separated from the decoding.

The optimal approach, however, is maximal-likelihood decoding, that requires searching through a large space of all possible combinations. In the case of N-QAM, with Ms transmitted streams, this requires N^{Ms} possible combinations, making it computationally intensive.

A Receiver According to the Invention

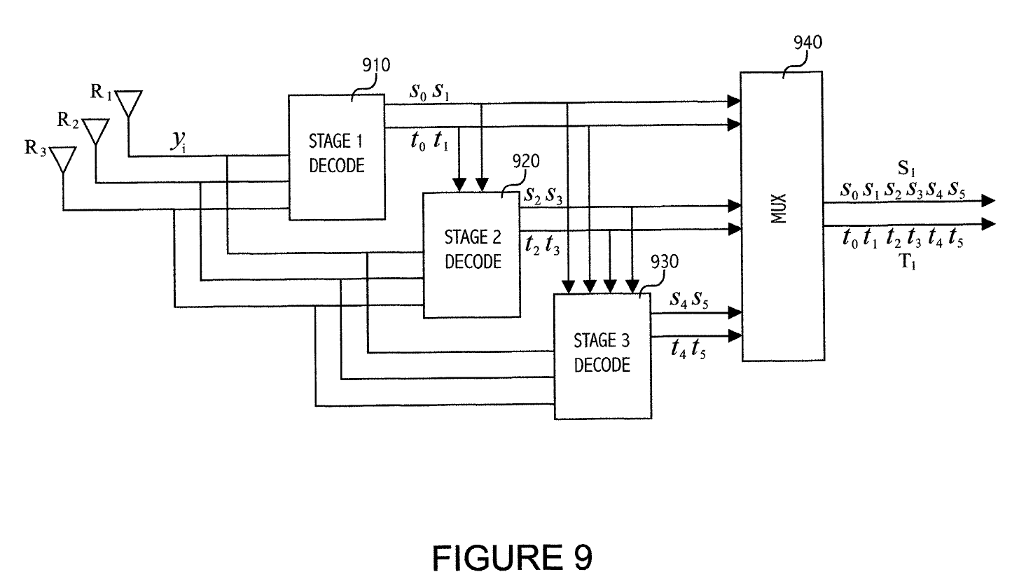

FIG. 9 shows an embodiment of a MIMO receiver according to the invention. This embodiment of the invention include three receiver antennae R1, R2, R3. Signals received by the three receiver antennae R1, R2, R3 drive several decoder stages 910, 920, 930.

The decoder stages 910, 920, 930 each decode a corresponding set of bits from within the received symbols.

The first decoder stage 910 decodes a first code word of bits. Each bit, or specified groups of bits from the first code word form a specified bit or specified group of bits within a designated symbol. For example, the first decoder stage 910 of FIG. 9 generates a first bit s0 and a second bit s1 of a symbol S1, and a first bit t0 and a second bit t1of another symbol T1.

The second decoder stage 920 decodes a second code word of bits. Each bit, or specified groups of bits from the second code word form a specified bit or specified group of bits within a designated symbol. For example, the second decoder stage 920 of FIG. 9 generates a thirdbit s2 and a fourth bit s3 of the symbol SI, and a thirdbit t2 and a fourth bit t3 of the other symbol T1.

Before decoding, the second decoder 920 subtracts the decoded bits from the first stage decoder 920 from the designated symbol. Generally, the first code word of bits is of greater significance within the symbol than the second code word of bits. By subtracting the decoded bits from the first stage decoder 910 before decoding the second code word, the decoding of the second code word is more efficient.

The third decoder stage 930 decodes a third code word of bits. Each bit, or specified groups of bits from the third code word form a specified bit or specified group of bits within a designated symbol. For example, the third decoder stage 930 of FIG. 9 generates a fifthbit s4 and a sixth bit s5 of the symbol S1, and a fifth t4 and a sixth bit s5 of the other symbol T1.

Before decoding, the third decoder 930 subtracts the decoded bits from the first stage decoder 910, and the decoded bits from the second stage decoded 920 from the designated symbol. Generally, the first code word of bits, and the second code word of bits are of greater significance within the symbol than the third code word of bits. By subtracting the decoded bits from the first stage decoder 910 and the second stage decoder 920 before decoding the second code word, the decoding of the third code word is more efficient.

The first bit s0, the second bit s1, the third bit s2, the forth bit s3, the fifth bit s4 and the sixth bit s5 of the first symbol S1 can be recombined through a multiplexer 940. The first bit t0, the second bit t1, the third bit t2, the fourth bit s3, the fifth bit s4 and the sixth bit s5 of the second symbol S2 can be also be recombined through the multiplexer 940.

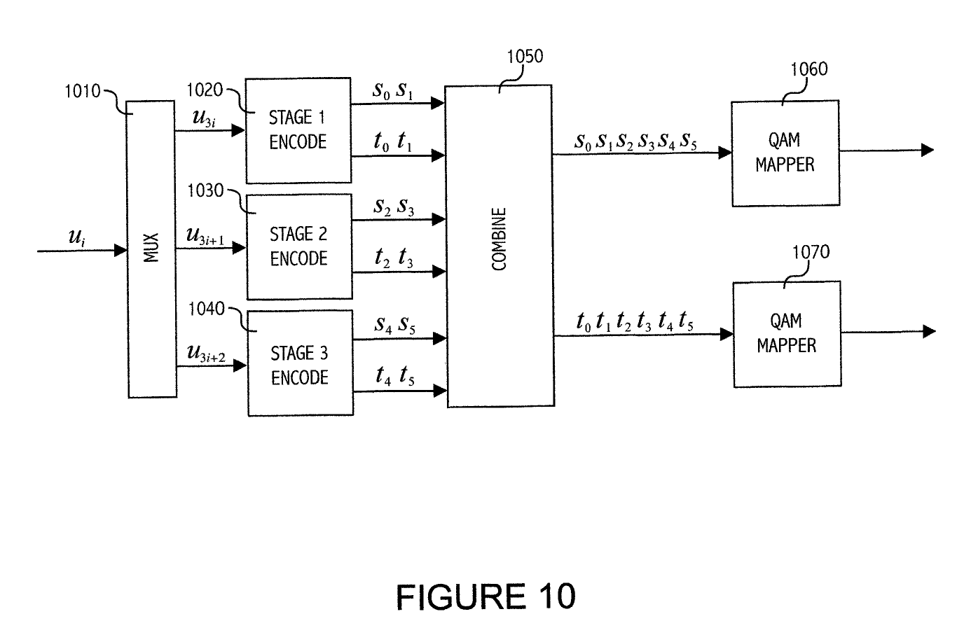

FIG. 10 shows a transmitter that corresponds with the receiver of FIG. 9. An encoded data stream uᵢ is received by a multiplexer (mux) 1010. The multiplexer 1010 separates the data stream into separate layers uᵢ₃, U₃ᵢ₊₁, U₃ᵢ₊₂. Generally, the layers are defined by the significance of bits of symbols within the data streams. Here, the data stream u₁ is separated into three streams.

A first layer encoder 1020 encodes a first pair of bits from the data stream u₁ and generates layer one bits s₀, s₁, t₀, t₁. A second layer encoder 1030 encodes a second pair of bits from the data stream u, and generates layer two bits s₂, s₃, t₂, t₃. A third layer encoder 1040 encodes a third pair of bits from the data stream u, and generates layer three bits s₄, s₅, t₄, t₅.

Each of the encoders 1020, 1030, 1040 generally include a coder, an interleaver and either a serial to parallel converter, or a multiplexer for generating two streams of encoded bits.

A combiner 1050 receives the layer one bits s₀, s₁, t₀, t₁, the layer two bits s₂, s₃, t₂, t₃, the layer three bits s₄, s₅, t₄, t₅, and generates two parallel coded bit streams for transmission. A first coded bit stream includes a six bit symbol that includes the layer one bits s₀, s₁, the layer two bits s₂, s₃, and the layer three bits s₄, s₅. A second coded bit stream includes a six bit symbol that includes the layer one bits t₀, t₁, the layer two bits t₂, t₃, and the layer three bits t₄, t₅. Generally, the first coded bit stream and the second coded bit stream are transmitted from spatially separate antennae.

A first QAM mapper 1060 and a second QAM mapper 1070 generate QAM signals based upon symbols formed by the parallel coded bit streams. Here, the symbols include six bits, which corrsponds with 64-QAM. The QAM signals are each transmitted from spatially separate antennae.

Adaptation to Poor Transmission Links

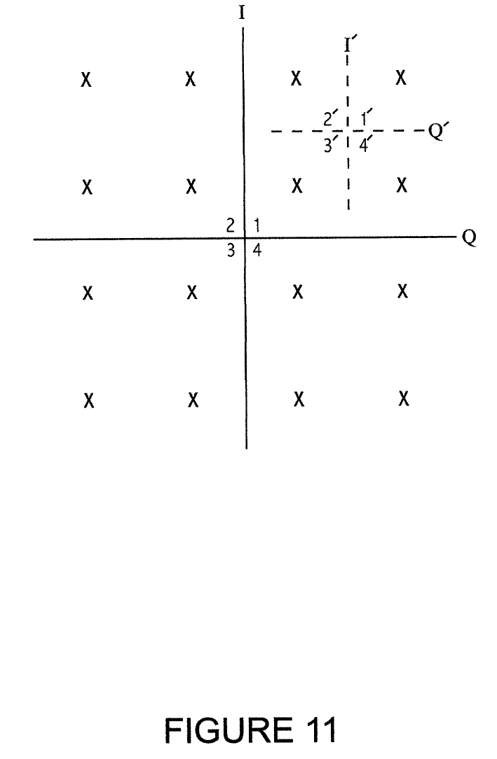

FIG. 11 shows a QAM constellation that depicts link adaptation advantages of the invention.

The QAM constellation shown in FIG. 11 is a 16-QAM constellation. Four states exist in each of the four separate quadrant designated 1, 2, 3, 4. A determination of which quadrant a symbol belongs to can be determined by the first two (most significant) bits of the symbol (a 16-QAM symbol includes four bits).

The quadrants 1, 2, 3, 4 are further separated into four subquadrants 1′, 2′ 3′, 4′. The determination of which subquadrant a symbol belongs to can be determined by the next two most significant bits of the symbol.

For constellations that include more than four bits (for example, 64-QAM), the subquadrant can by further separated into four sub-subquadrants. The determination of which sub-subquadrant a symbol belongs to can be determined by the next two most significant bits of the symbol.

Observation of the constellation of FIG. 11 suggests that decoding the first stage (the two most significant) bits is easier than decoding the second stage (second most significant two) bits, since decoding the second stage requires knowing the first stage as well. The key of this layered approach is to decode each level independently, and use the corrected data at one stage to enable the decoding of the next stage. This is a novel approach in the context of multiple receive and transmit antennae.

An apparent advantage to the layered coding of the invention is that by coding each stage separately, it becomes possible to transmit partial data (for example, the first stage or the first two stages) when the channel conditions do not support 64-QAM performance. Therefore, depending upon the quality of the transmission channel, multi-stage coding allows partial data to be transmitted. This can be useful, for example, in the absence of link adaptation, or in the case where the link adaptation scheme overestimates the appropriate transmission modulation due to rapidly changing channel conditions. This approach can also apply to the use of a coding scheme that is inappropriate due to rapidly changing channel conditions.

Multi-stage coding can effectively be used in broadcast systems that use spatially multiplexed antennae. In broadcast systems, it is not possible to use link adaptation for each user. Multi-stage coding allows data packets to be transmitted successfully without the need to know the appropriate transmit modulation.

Each successive stage of decoding requires a higher quality signal to determine which quadrant a decoded symbol should be designated. The quality of the signal is typically measured by a channel condition parameter (such as signal to noise ratio). Therefore, it follows that early stages of decoding require smaller signal to noise ratios (SNRs) than later stages of decoding. Redundancy in coding can be adjusted appropriately depending upon the stage being coded. That is, later stage coding can include more redundancy than early stage coding.

An Example of an Embodiment of the Invention

A sample system can include Mt transmit antennae and N=1000 active tones per slot in an OFDM system, in which 64-QAM symbols are being transmitted. An embodiment includes three separate error-correction codewords for the three stages. Each stage can include two bits. For example, of the six bits required for a 64-QAM symbol, the first stage can include the most significant bit (s0, s1), the second stage can include the next most significant bits (s2, s3), and the third stage can include the least significant bits (s4, s5).

The length of each codeword is 2MₜN=4000 bits. Each codeword covers a different stage of decoding. In general, the error-correcting code can cover multiple tones and multiple transmit antennae.

The decoding procedure begins by estimating the bits within the first stage. There are 4^{Mt} possible combinations of these bits because there are two bits per transmit antennae. There are several possible techniques that can be used to estimate these bits.

For small values of Mₜ, it is possible to use a maximum likelihood decoder for estimating the received bits. For larger values of Mₜ, it is possible to use some combination of techniques, including linear filters, iterative and successive cancellation techniques.

Error correction coding is then applied to the first stage of bits. The result of the error-correction should contain no errors. If any errors exist after decoding, then retransmission is required.

The corrected bits from the first stage correction are subtracted from the appropriate signals. After the subtraction, the second stage bit information becomes easy to determine. The second stage information is then determined using the same process and techniques as the first stage bits to determine estimates or soft metrics for bits in the second stage.

Error correction coding is then applied to the second stage of bits.

The corrected bits from the second stage correction are subtracted from the appropriate received signals. After the subtraction, the third stage bit information should be all that remains. The third stage information is then determined using the same process and techniques as the first stage bits to determine estimates or soft metrics for bits in the third stage.

The use of coding corrects the errors at each stage. The multistage error-correction technique provides a method for reducing the complexity of decoding, especially for systems having multiple transmit antennae and using spatial multiplexing.

Instead of transmitting a regular 64-QAM constellation, it is possible to consider other constellations that can be used for multistage decoding. For example, the placement of the 64 constellation points of a 64-QAM system can be adjusted to make the constellation more appropriate for the techniques of the invention.

Although specific embodiments of the invention have been described and illustrated, the invention is not to be limited to the specific forms or arrangements of parts so described and illustrated. The invention is limited only by the claims.

What is claimed:

1. A method of error correction coding data wirelessly transmitted through multiple transmission channels, the method comprising:
receiving a plurality of data streams for transmission through spatially separate antennae;
selecting at least one bit from each of a plurality of the data streams forming a first bit grouping;
selecting at least one other bit from each of the plurality of the data streams forming a second bit grouping;
coding the first bit grouping;
coding the second bit grouping; and
transmitting the coded first bit grouping and the coded second bit grouping.

2. The method of error correction coding of claim 1, wherein selecting at least one bit from each of a plurality of the data streams forming a first bit grouping comprises selecting a plurality of bits from each data stream.

3. The method of error correction coding of claim 1, wherein selecting at least one bit from each of a plurality of the data streams forming a second bit grouping comprises selecting a plurality of other bits from each data stream.

4. The method of error correction coding of claim 1, wherein each data stream is transmitted from a corresponding spatially separate antenna.

5. The method of error correction coding of claim 1, wherein the plurality of data streams are generated from a single primary data stream.

6. The method of error correction coding of claim 1, wherein coding the first bit grouping comprises coding the first bit grouping according to at least one of Reed-Solomon coding, turbo coding, convolutional coding and low-density parity check coding.

7. The method of error correction coding of claim 1, wherein coding the second bit grouping comprises coding the second bit grouping according to at least one of Reed-Solomon coding, convolutional coding, turbo coding and low-density parity check coding.

8. The method of error correction coding of claim 1, wherein the data streams comprise N-QAM symbols.

9. The method of error correction coding of claim 8, wherein selecting the first bit grouping and the second bit grouping is based upon the significance of the bits within the N-QAM symbols.

10. The method of error correction coding of claim 9, wherein selecting the first bit grouping and the second bit grouping include selecting a plurality of bits from the N-QAM symbols from the plurality of the bit streams.

11. The method of error correction coding of claim 9 wherein a redundancy in coding the first bit grouping and coding the second bit grouping is dependent upon the significance of the bits within the first bit grouping and the second bit grouping.

12. The method of error correction coding of claim 8, wherein the N-QAM symbols of the data streams are modulated on simultaneously transmitted multi-carrier signals after the bits of the N-QAM symbols have been coded.

13. The method of error correction coding of claim 12, wherein the multi-carrier signals are orthogonal frequency division multiplexed (OFDM) signals.

14. A method of error correction decoding data wirelessly received through multiple transmission channels, the method comprising:
receiving a plurality of data streams received through spatially separate antennae;
selecting at least one bit from each of the plurality of the data streams forming a first bit grouping;
selecting at least one other bit from each of the plurality of the data streams forming a second bit grouping;
decoding the first bit grouping;
decoding the second bit grouping; and
constructing decoded bit streams based upon the decoded first bit grouping and the decoded second bit grouping.

15. The method of error correction decoding of claim 14, wherein selecting at least one bit from each of a plurality of the data streams forming a first bit grouping comprises selecting a plurality of bits from each data stream.

16. The method of error correction decoding of claim 14, wherein selecting at least one bit from each of a plurality of the data streams forming a second bit grouping comprises selecting a plurality of other bits from each data stream.

17. The method of error correction decoding of claim 14, wherein each data stream is received from a corresponding spatially separate antenna.

18. The method of error correction decoding of claim 14, wherein decoding the first bit grouping comprises decoding the first bit grouping according to at least one of Reed-Solomon decoding, turbo decoding and low-density parity check decoding.

19. The method of error correction decoding of claim 14, wherein decoding the second bit grouping comprises decoding the second bit grouping according to at least one of Reed-Solomon decoding, turbo decoding and low-density parity check decoding.

20. The method of error correction decoding of claim 14, wherein the data streams comprise N-QAM symbols.

21. The method of error correction decoding of claim 20, wherein selecting the first bit grouping and the second bit grouping is based upon the significance of the bits within the N-QAM symbols.

22. The method of error correction decoding of claim 21, wherein selecting the first bit grouping and the second bit grouping include selecting a plurality of bits from the N-QAM symbols from the plurality of the bit streams.

23. The method of error correction decoding of claim 20, wherein the N-QAM symbols of the data streams are modulated on simultaneously transmitted multi-carrier signals.

24. The method of error correction decoding of claim 23, wherein the multi-carrier signals are orthogonal frequency division multiplexed (OFDM) signals.

25. A method of multistage error decoding, comprising:
receiving a plurality of data streams through spatially separate antennae;
generating first level bits based upon decoding of first common bit groupings within the received data streams;
generating second level bits based upon:
subtracting the first level bits from the received plurality of data streams;
decoding of second common bit groupings within the received data streams; and
combining the first level bits and the second level bits forming multistage decoded bit streams.

26. The method of multistage error decoding of claim 25, wherein the first common bit groupings and the second common bit groupings are different groups of bits having different levels of significance within symbols of the data streams.

27. The method of multistage error decoding of claim 26, wherein the symbols of the received data streams are N-QAM symbols.

28. The method of error correction decoding of claim 27, wherein the N-QAM symbols of the data streams are modulated on simultaneously transmitted multi-carrier signals.

29. The method of error correction decoding of claim 28, wherein the multi-carrier signals are orthogonal frequency division multiplexed (OFDM) signals.

30. A system for error correction coding data wirelessly transmitted through multiple transmission channels, the system comprising:
means for receiving a plurality of data streams for transmission through spatially separate antennae;
means for selecting at least one bit from each of a plurality of the data streams forming a first bit grouping;
means for selecting at least one other bit from each of the plurality of the data streams forming a second bit grouping;
means for coding the first bit grouping;
means for coding the second bit grouping; and
means for transmitting the coded first bit grouping and the coded second bit grouping.
